(19) United States
(12) Patent Application Publication
(10) Pub. No.: US 2007/0087078 A1
(43) Pub. Date: Apr. 19, 2007

(54) Molding tool for the production of plastics moldings by the reaction injection molding process

(75) Inventors: Klaus Franken, Bergisch Gladbach (DE); Ernst-Martin Hoppe, Bergisch Gladbach (DE); Friedhelm Faehling, Koln (DE); Dirk Bruning, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/546,725

(22) Filed: Oct. 12, 2006

(30) Foreign Application Priority Data
Oct. 18, 2005 (DE) 102005049640.7

(51) Int. Cl. B29C 45/00

(52) U.S. Cl. 425/557

(57) ABSTRACT

A molding tool for the production of plastics moldings by the reaction injection molding process is described. These plastics moldings are preferably prepared from a reaction mixture comprising a polyurethane molding composition. The molding tool comprises at least two molding tool halves, i.e. an upper mold half and a lower mold half, which together form a mold cavity when in the closed position, a supply pipe for transporting the reaction mixture via an external mixing head connector which connects the supply pipe to an external mixing head, a storage chamber which receives the reaction mixture from the supply pipe, and a plunger which is movably arranged in the storage chamber, characterised in that the end face of the plunger forms part of the inside wall of the mold cavity formed by the two mold halves when the plunger is in the extended state.

### CROSS REFERENCE TO RELATED PATENT APPLICATION

The present patent application claims the right of priority under 35 U.S.C. §119 (a)-(d) of German Patent Application No. 10 2005 049 640.7, filed Oct. 18, 2005.

### BACKGROUND OF THE INVENTION

The invention relates to a molding tool suitable for the production of plastics moldings by the reaction injection molding process and to a process for the production of plastics moldings via this molding tool in which the plastic material is a polyurethane molding composition.

There is a need for moldings which, in particular, are made of polyurethane (PUR), and which have a comparatively low component volume of not more than about 15 cm³, based on the PUR. Typical applications for such moldings are in the electrical and electronics field in the sheathing of electronic components such as boards, switches, etc. Currently, many of these components are produced by the thermoplastic injection molding process, but they come up against technical limitations due to the high pressure inside the molding tool and the high temperature of the molten thermoplastics material. The plastics material PUR is superior in terms of process technology and is processed into a molding by the reaction injection molding process (also known as RIM). The quality of a molding produced by the RIM process using PUR is very dependent inter alia on the geometry of the component and the fill time. If the cavity of the molding tool is filled too quickly, this can lead to air inclusions in the PUR plastics material and to density problems, in particular when inserts (i.e. structural elements which are to be connected to the plastics material, e.g. electronic components) are to be incorporated into the plastics molding.

The reaction injection molding machine is accordingly required to deliver a specific volume flow of PUR reaction mixture which is sufficiently small to allow a small cavity to be filled sufficiently slowly.

According to the current state of the art, high-pressure machines are able to achieve minimal volume flows of the order of about 10 to 15 cm³/s. The meterable amount of an individual “shot” (i.e. the minimum amount of PUR reaction mixture delivered) is in the region of about 1 cm³. Moreover, depending on the geometry of the component, fill times of from 2 to 3 seconds or more are required in order to produce plastics moldings that are as free of faults as possible. The minimal volume of components that can be produced according to the current state of the art is accordingly about 20 to 45 cm³, depending on whether fillers are to be processed or not.

Although it is possible to reduce the volume flow per component by the use of multiple tools or blind cavities, this is not always desirable.

WO 96/41715 A1 describes the filling of a cavity using a so-called storage plunger. The storage plunger is arranged perpendicularly to the parting plane of the tool and is filled directly from the mixing head. As it is filled, the storage plunger is pushed back. In order that the build up in pressure required to push the storage plunger back, the entrance to the cavity of the mold must initially be closed during filling of the storage plunger. When the cavity is opened, the storage plunger can be pushed out and the cavity is filled via a gate system. This solution is technically markedly more complex than the solution described in the present invention. In addition, it leaves behind on the molding a sprue, which subsequently has to be removed.

### SUMMARY OF THE INVENTION

The object of the invention was, starting from the known devices for the reaction injection molding process, to develop a novel tool or apparatus for the reaction injection molding process using polyurethane molding compositions, which operates in such a manner that even the mold cavities which have a volume for the plastics composition of considerably less than 15 cm³ can be filled over sufficiently long times (i.e. 2 to 3 seconds or more).

This object is achieved by developing a novel molding tool suitable for the production of plastics moldings by the reaction injection molding process in which the plastic materials is a polyurethane molding composition. This molding tool has a specially designed storage chamber, with a movable plunger located within the storage chamber.

The invention provides a molding tool for the production of plastics moldings by the reaction injection molding process in which the plastic material comprises a polyurethane composition. This molding tool comprises
(1) at least two molding tool halves which form a mold cavity when in the closed position,
(2) a supply pipe for receiving and transporting the reaction mixture from an external source,
(3) a storage chamber for receiving the reaction mixture from the supply pipe,
(4) a plunger which is movably arranged within the storage chamber, and which is capable of pushing the reaction mixture out of the storage chamber and into the mold cavity formed by closing the molding tool halves,
(5) a connector which connects an external source which mixes the reaction mixture to the entrance of the supply pipe,
   wherein the plunger end face forms part of the inside wall of the mold cavity formed by the molding tool halves when the plunger is in the extended state.

### BRIEF DESCRIPTION OF THE FIGURES

FIG. 1, a top view of a cross-section of the molding tool according to the invention, in which only the bottom half of the molding tool is shown.

FIG. 2, a side view of a cross-section of the closed molding tool of FIG. 1, which was cut perpendicularly to the parting plane 11.

FIG. 3, a top view of a cross-section of the molding tool as shown in FIG. 1, in which the storage chamber is filled with reaction mixture.

FIG. 4, a side view of a cross-section of the closed molding tool as shown in FIG. 2, in which with the plunger is extended and the cavity is filled with reaction mixture.

FIG. 5, a top view of a cross-section of the lower mold half of a opened molding tool according to the invention, in which a cross-section has been cut lengthwise through the lower mold half. In FIG. 5, the plunger is perpendicular to the drawing plane in which the figure lies. The viewer is looking down through the storage chamber onto the plunger so that the storage chamber is not visible.

FIG. 6, a side view of a cross-section of the closed molding tool in FIG. 5, with the plunger 3 retracted.

FIG. 7, a top view of a cross-section of an open molding tool similar to that of FIG. 1, in which the supply pipe opens into the storage chamber at the side of the storage chamber.

FIG. 8, a side view of a cross-section of the closed molding tool of FIG. 7.

### DETAILED DESCRIPTION OF THE INVENTION

As used herein, the extended state of the plunger means that the plunger has been pushed forwards in the storage chamber to the end of the storage chamber. Thus, when the plunger is in the extended state, the end face of the plunger forms part of the wall of the mold cavity of the molding tool.

As used herein, the retracted state of the plunger means that the plunger has been pulled back out of the storage chamber. When retracted, the plunger end face is removed from the wall of the mold cavity, and an opening exists between the storage chamber and the mold cavity of the molding tool.

It is through this opening between the storage chamber and the mold cavity that the reaction mixture in the storage chamber can be moved from the storage chamber into the mold cavity. The storage chamber is, of course, filled with reaction mixture from the supply pipe. The plunger is retracted to allow the storage chamber to be filled with reaction mixture.

The idea underlying the invention is that the reaction mixture is not introduced directly into the component cavity of the mold, but is first introduced into a storage chamber which is located upstream of the actual component cavity. The storage chamber is connected to the component cavity. The storage chamber must be in such a form that its contents can be ejected with the aid of a plunger. The reaction mixture thereby flows from the storage chamber into the component cavity when the plunger is extended. The variable speed of the plunger on ejection of the contents of the storage chamber then determines the volume flow for filling of the component cavity. The time until gelling (or before) of the PUR system can be used fully.

In a preferred embodiment of the molding tool, the gate of the supply pipe for the reaction mixture is located in the region close to the end face of the plunger when the plunger is in the retracted state in the storage chamber. A particularly preferred variation thereof is characterised in that the gate of the supply pipe for the reaction mixture is located directly at the end face of the plunger when the plunger is in the retracted state in the storage chamber. Reliable filling of the cavity is thereby ensured, without material passing prematurely into the cavity, as a result of the high flow rate of the mixture when it is introduced into the storage chamber.

In one embodiment of the present invention, the plunger of the storage chamber is located in the parting plane of the molding tool halves, i.e. where the upper and lower mold halves separate when opening the molding tool. The frictional forces that occur during the displacement of the plunger can be minimised by using materials that are less rigid than the material of the molding tool (e.g. Teflon-coated plunger). A particular advantage of this embodiment is that filling of the storage chamber can be carried out via a gate at the end face of the plunger. As a result, it is possible to achieve a flow that is as laminar as possible, adheres to the wall as much as possible and is as free of included air as possible, even with comparatively high volume flows. In addition, the mentioned embodiment is technically easy to convert and is easy to clean. In another embodiment, the plunger moves perpendicularly to the parting plane of the molding tool halves (i.e. where the upper and lower mold halves separate when opening the molding tool) or at an angle thereto. In this embodiment it is advantageous that the plunger does not experience increased frictional forces as a result of the closing force of the molding tool, because it is not located in the parting plane of the molding tool. It is therefore not necessary to take measures to reduce such frictional forces in this embodiment.

When designing the storage chamber, its volume is important. In a preferred embodiment of the invention, the volume of the storage chamber should be at least as great as the volume of the mold cavity regions that are to be filled. If the chamber is too small, reaction mixture flows into the mold cavity even while the storage chamber is being filled. According to the geometry of the mold cavity, and depending on whether and where inserts are provided, undesirable air inclusions could occur even at this stage. If the geometry of the mold cavity or the position of inserts is advantageous, however, even a storage chamber that holds only 80% of the mold volume can still result in high-quality molded components. An oversized storage chamber would not, however, have any negative consequences. Slight oversizing of the storage chamber would even be helpful in order to allow more reaction mixture to be introduced into the mold cavity than the cavity actually holds. If the mold cavity is full and reaction mixture still continues to flow in, it is able to escape from the cavity through vents provided for that purpose and, in so doing, can carry with it any included air (i.e. through standard tool venting).

In a further preferred embodiment of the molding tool, the supply pipe is arranged in the parting plane of the molding tool halves.

In order to prevent the premature entry of reaction mixture into the mold cavity of the molding tool, the ratio of the width of the storage chamber to its length is chosen in a particularly preferred embodiment of the present invention to be at least 1 to 3, preferably at least 1 to 4. The longitudinal extent of the storage chamber is typically arranged parallel to the direction of gravity.

Particular preference is given to an embodiment of the device in which the storage chamber is arranged with the longitudinal extent of the storage chamber parallel to the direction of gravity, and with the opening of the storage chamber into the mold cavity pointing upwards. In other words, the opening of the storage chamber into the cavity is at the highest point of the storage chamber.

A further important design point is the form of the gate for the storage chamber. The storage chamber is filled with the volume flow of the reaction injection molding machine, which is a volume flow that is generally too high for the component cavity to be filled directly at from the reaction inject molding machine. However, because the gate to the storage chamber can be so constructed to produce a flow of sufficiently low speed such that the reaction mixture entering the storage chamber adheres to the wall, and the introduction of air during filling of the storage chamber can be kept sufficiently small despite the high volume flow.

The invention relates also to the use of the novel molding tool in the production of plastics moldings by the reaction injection molding process, and in particular, in which polyurethane molding compositions are used as the reaction mixture.

The following components are suitable in principle as the reaction mixture:

There are suitable as the reaction mixture in principle any mixtures of polyol components, including auxiliary substances and additives, with polyisocyanates. The polyol components, including auxiliary substances and additives, and the polyisocyanates are preferably reacted with one another in the range of from 90 to 120% of the stoichiometric ratio.

With regard to the polyol component, preference is given to the use of polyethers that contain at least 2 isocyanate-reactive active hydrogen atoms and that have a molecular weight of from 100 to 5000, preferably from 120 to 1500, particularly preferably from 300 to 800. They are obtained, for example, by polyaddition of alkylene oxides, such as, for example, ethylene oxide, propylene oxide, butylene oxide, dodecyl oxide or styrene oxide, preferably propylene oxide and/or ethylene oxide, to aromatic mono-, di- or poly-amines, such as aniline, phenylenediamine, toluylenediamine, 2,2′-diaminodiphenylmethane, 2,4′-diaminodiphenylmethane, 4,4′-diaminodiphenylmethane or mixtures of these isomers.

There are used as long-chained polyols in particular also polyether polyols, polyether ester polyols and polyester polyols, or castor oil. Suitable organic polyhydroxyl compounds are any desired compounds, known from polyurethane chemistry, having at least 2, preferably from 2 to 8, particularly preferably from 2 to 4, hydroxyl groups. They include, for example, the known linear or branched polyether polyols having a molecular weight in the range from 150 to 8000, preferably from 150 to 4000. Suitable polyether polyols are the alkoxylation products, known per se, of suitable starter molecules, such as, for example, water, ethylene glycol, diethylene glycol, propylene glycol, dipropylene glycol, butanediol, butenediol, butynediol, bisphenol A, trimethylolpropane, glycerol, sorbitol, sucrose or any desired mixtures of such starter molecules, using ethylene oxide and/or propylene oxide as alkoxylating agent. Suitable polyester polyols are, for example, those based on the mentioned alcohols and polybasic acids, such as, for example, adipic acid, phthalic acid or hexahydrophthalic acid, or castor oil.

Suitable short-chained polyols, especially having molecular weights of from 62 to 400, include, for example, triethylene glycol, tetraethylene glycol, glycerol, tripropylene glycol or tetrapropylene glycol. Also suitable are amino alcohols, such as, for example, triethanolamine.

Any desired possible auxiliary substances and additives for the reaction mixture are in particular colourings, plasticisers, fillers, such as, for example, aluminium hydroxides or oxides, chalk and dolomite, reinforcing materials such as glass fibres or glass spheres or hollow spheres, catalysts such as, for example, tertiary amines, such as tetraethylenediamine or dimethylbenzylamine, or catalysts based on organometals, such as, for example, tin(II) octoate, dibutyltin dilaurate, or organic bismuth compounds, water-adsorbing additives, such as, for example, zeolites, flameproofing agents, such as, for example, the organophosphorus compounds used for that purpose in polyurethane chemistry, and flow aids. The auxiliary substances and additives that are optionally to be used concomitantly are generally added to the polyol component, although it is also possible in principle to mix them with the polyisocyanate component.

Suitable polyisocyanates for the reaction mixture are especially aliphatic, heterocyclic and, in particular, di- and/or poly-isocyanates, as are described, for example, by W. Siefken in Justus Liebigs Annalen der Chemie, 562, pages 75-136, for example those of the formula Q(NCO)n, wherein n represents a number from 2 to 4, preferably from 2 to 3, and Q represents an aromatic hydrocarbon radical having from 6 to 20 carbon atoms, preferably having from 6 to 13 carbon atoms. It is also possible to use polyisocyanates as described in DE-A 28 32 253, pages 10-11. Particular preference is given to polyisocyanates that are readily obtain able commercially, for example 2,4′- and/or 2,6′-toluylene diisocyanate as well as any desired mixtures of these isomers (“TDI”), diphenylmethane diisocyanates (4,4′- and/or 2,4′- and/or 2,2′-isomers), polyphenylpolymethylene polyisocyanates, as are prepared by aniline-formaldehyde condensation and subsequent phosgenation (“crude MDI”), and modified polyisocyanates that contain, for example, carbodiimide groups, urethane groups, allophanate groups, isocyanate groups, urea groups and/or biuret groups, in particular those modified polyisocyanates that are derived from 2,4′- and/or 2,6′-toluylene diisocyanate or from 4,4′- and/or 2,4′-diphenylmethane diisocyanate.

The invention also provides a process for the production of plastics moldings by the reaction injection molding process, in particular by means of polyurethane molding compositions as used as the reaction mixture, using the molding tool according to the invention. This process is characterised in that the reaction mixture is injected from the mixing head of the reaction injection molding machine by the connector to the supply pipe and into the storage chamber, in particular within a period of less than 1 second. Then, within the gelling time of the reaction mixture, the reaction mixture is introduced into the mold cavity from the storage chamber with the aid of the plunger, and is hardened in the mold cavity, and the molding is subsequently removed from the cavity.

Preference is given to a process which is characterised in that reaction mixture in an amount of not more than 15 cm³ is used for filling the storage chamber.

According to the current state of machine technology, it is no longer possible to fill a component cavity having a volume of less than 15 cm³ within a period of from 2 to 3 seconds using a high-pressure reaction injection molding machine. The reason for this is the insufficient mixing of the reaction components in the mixing head if the high-pressure reaction injection molding machine is operated with too low a volume flow. On the other hand, if the mold cavity is filled with a volume flow that is sufficiently high for the mixing head, the flow velocities in the gate of the mold cavity, and in particular, around any possible inserts, are so great that air inclusions and density problems make the component quality unacceptable. A solution to this is provided by the molding tool described in the present invention. As a result of the special design of the storage chamber in aspects such as its extent (i.e. length to width ratio), the gate having a sufficiently large surface area, the flow that adheres to the wall during filling, and the absence of any inserts or other obstructions to the flow of reaction mixture into the storage chamber, it is possible to fill the storage chamber with a comparatively high volume flow even without air inclusions. The minimal volume flows of about 10 to 15 cm³/s provided by machine technology are sufficient therefor. The storage chamber which is thus filled without faults can then be injected into the mold cavity, within the gelling time of the reaction mixture, but sufficiently slowly such that air inclusions do not occur in the cavity either.

A further advantage of the use of the above-described technique is that the end face of the plunger can be in any form as regards its geometry. For example, the end face of the plunger can be formed as the negative of the component geometry and accordingly, after closing of the plunger, can form part of the wall of the cavity. This would result in a component without an adhering sprue.

Reference will now be made in greater detail to the Figures by way of Examples to further explain and describe the invention in greater detail. These Examples do not constitute a limitation of the invention.

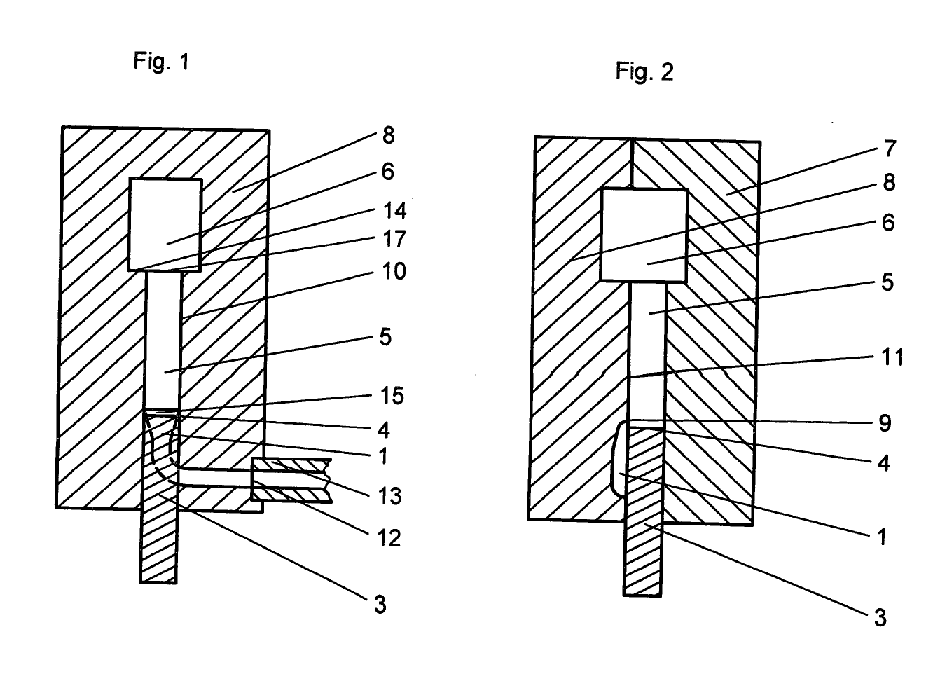

In FIGS. 1-8, the reference numerals have the meanings given below:
1 supply pipe to the plunger end face
1′ supply pipe to the longitudinal side of the storage chamber
2 film-shaped gate or orifice
3 plunger
4 plunger end face
5 storage chamber
6 mold cavity
7 upper mold half
8 lower mold half
9 curved portion of supply pipe which redirects flow of the reaction mixture
10 longitudinal side of the storage
11 parting plane
12 connector
13 mixing head
14 inside wall of the cavity of the molding tool
15 gate (opening)
16 reaction mixture
17 opening or orifice through which material exits the storage chamber and enters the mold cavity

### EXAMPLES

### Example 1

Reference will now be made to FIG. 1 which shows, by way of example, a top view of a cross-section cut longitudinally through a molding tool of the invention. (The parting plane in FIG. 1 lies parallel to the drawing area and thus can not been seen.) In FIG. 1, is shown a top view of the lower mold half 8 having a fan-shaped gate (not shown). In FIG. 1, the plunger 3 is fully retracted and covers part of the supply pipe 1. The gate 15 of the supply pipe 1 is located directly at the plunger end face 4 in the storage chamber 5, and guides the reaction mixture (not shown) from the mixing head 13 via the connector 12 to the storage chamber 5. (The mixing head 13 is not part of the inventive apparatus.) In this embodiment of the molding tool, the orifice 17 through which reaction mixture exits the storage chamber 5 and enters into the mold cavity 6 is located perpendicularly to the longitudinal side of the storage chamber 10. When the plunger 3 is fully extended, the plunder end face 4 closes the orifice 17 and forms part of the inside wall 14 of the cavity of the molding tool.

Reference will now be made to FIG. 2 which is a side view of a cross-section of the closed molding tool as shown in FIG. 1, which was cut perpendicularly to the parting plane 11. Both the upper mold half 7 and the lower mold half 8 are shown in FIG. 2, as is the mold cavity 6 which is formed by the upper and lower mold halves 7 and 8. As a result of the curved portion 9 of the supply pipe 1, the reaction mixture (not shown) is redirected and flows in a first step into the storage chamber 5. This occurs in a shot time of about 0.5 second. In FIG. 2, the plunger 3 is fully retracted and covers part of the supply pipe. The curved portion 9 of the supply pipe allows the reaction mixture to enter the storage chamber 5 directly at the end face 4 of the plunger 3. When the plunger 3 is located in the parting plane 11 as shown in FIG. 2, the fan shaped gate can be positioned at various places in the storage chamber 5.

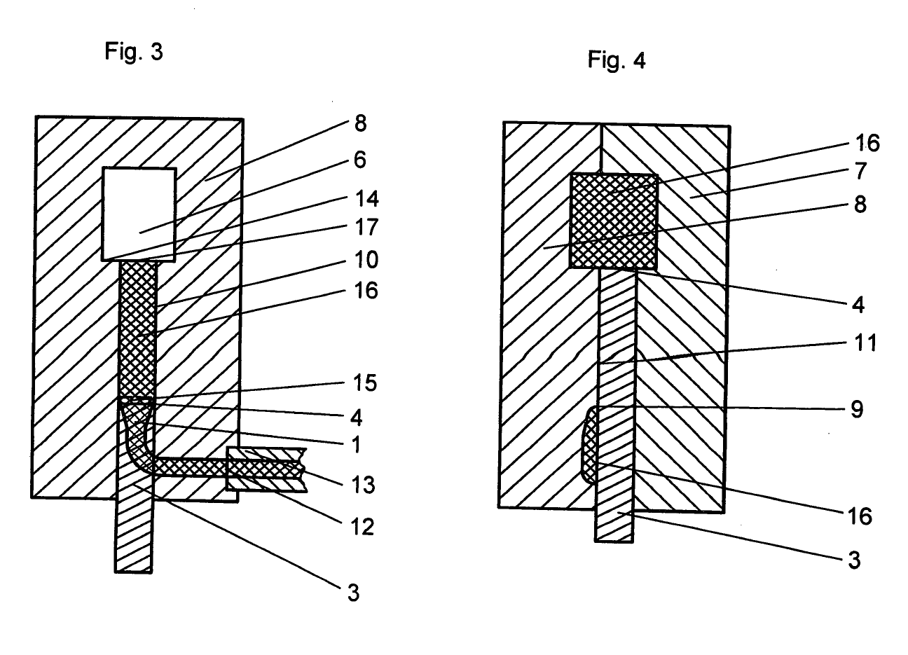

Reference will now be made to FIG. 3 which is a top view of a cross-section of the molding tool as shown in FIG. 1, which illustrates the entry of the reaction mixture 16 into the storage chamber 5, which here has been filled to the end. The plunger 3 is in the retracted state. However, if the plunger 3 is extended, the reaction mixture 16 would enter the mold cavity 6 through the orifice 17 which allows the reaction mixture 16 to exit from the storage chamber 5 and enter the mold cavity 6. Fully extending the plunger 3 would also position the plunger end face 4 in the orifice 17 and close or block it such that the plunger end face 4 would form part of the inside wall 14 of the mold cavity 6.

Reference will now be made to FIG. 4 which is a side view of a cross-section of the closed molding tool as shown in FIG. 2, in which the plunger 3 is fully extended and the reaction mixture 16 fills the mold cavity 6. Both the upper mold half 7 and the lower mold half 8 are shown in FIG. 4. When the plunger 3 is fully extended as in FIG. 4, the plunger end face 4 forms part of the inside wall (not shown) of the mold cavity (not shown) of the molding tool. Once the reaction material 16 hardens, and the finished molded part can be removed from the molding tool. As in FIG. 2, the curved portion 9 of the supply pipe redirects the flow of the reaction mixture 16.

### Example 2

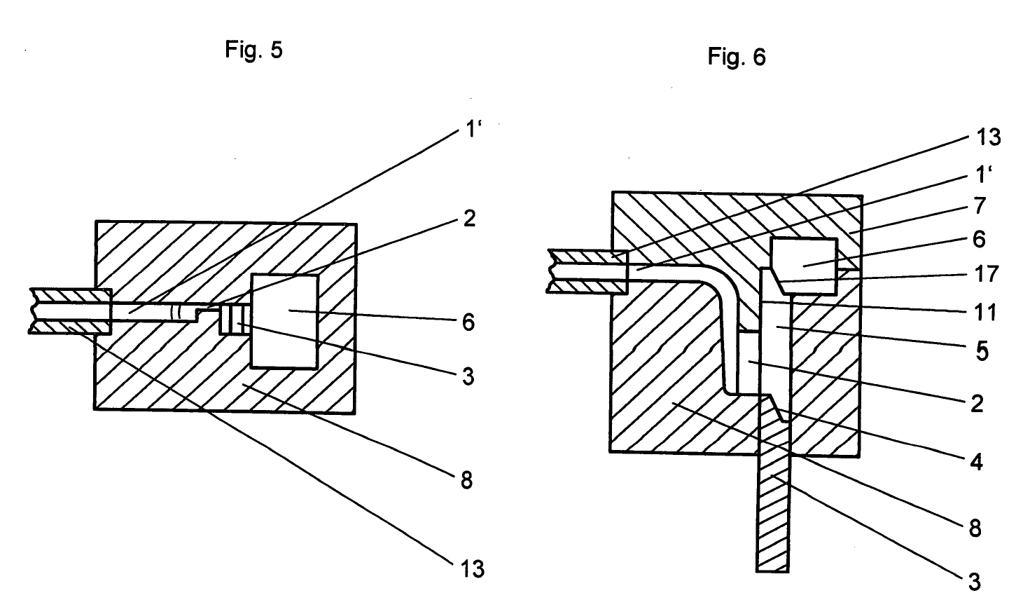

Reference will now be made to FIG. 5, which provides a top view of a cross-section of the lower mold half 8 in which the molding tool is opened. FIG. 5 is also illustrative of the invention. In FIG. 5, the lower mold half 8 is shown and it illustrates an embodiment of a tool in which the plunger 3 is arranged perpendicular to the drawing plane (i.e. the drawing plane is parallel to the drawing area and thus, lies in the same plane as upper surface of the cross-section of the lower mold half 8 which is shown). The storage chamber 5 is not visible in FIG. 5 as the plunger 3 is seen as the viewer looks through the empty storage chamber 5 and onto the plunger 3. FIG. 5 also shows a variation of a gate which is a rod-type gate which connects supply pipe 1′ to the storage chamber 5 (not visible as the viewer is looking through it onto plunger 3) by way of a narrow aperture or gate 2 (i.e. film-shaped gate). By the term “film-shaped gate”, it is meant that upon demolding of the part this aperture or gate is filled with plastic which resembles a film. Supply pipe 1′ transports reaction mixture (not shown) from an external source such as a mixing head 13 (not part of the inventive apparatus) through the connector 12 to the storage chamber which is located above the plunger 3 and thus, is not visible in this view.

Reference will now be made to FIG. 6 which illustrates a side view of a cross-section of the closed molding tool in FIG. 5, which was cut perpendicular to the parting plane 11. Both the upper mold half 7 and the lower mold half 8 are shown in FIG. 6, and the plunger 3 is shown in the retracted state. Once the main channel of the supply pipe 1′ is full of reaction mixture (not shown) from the mixing head 13 which attaches to the supply pipe 1′ by the connector 12, the reaction mixture flows into the storage chamber 5 at a sufficiently slow rate and adheres to the walls of the storage chamber 5. By moving the plunger 3 in a upward direction (i.e. by extending the plunger 3) the reaction mixture can be transferred from the storage chamber 5 to the mold cavity 6, with the plunger end face 4 closing the opening 17 of the storage chamber 5 to the mold cavity 6 such that the mold cavity 6 is closed for hardening of the mixture.

The geometry of the storage chamber 5, which does not contain any obstructions to the flow and can also be narrower (i.e. channel-like), has the effect that no air is enclosed in the reaction mixture even during further filling of the storage chamber 5. In order to prevent reaction mixture from passing into the mold cavity 6 during filling of the storage chamber 5, gravity is used which requires that the storage chamber 5 be located below the mold cavity 6. This also means that the opening 17 from the storage chamber 5 into the mold cavity 6 be located at the highest point of the storage chamber 5.

### Example 3

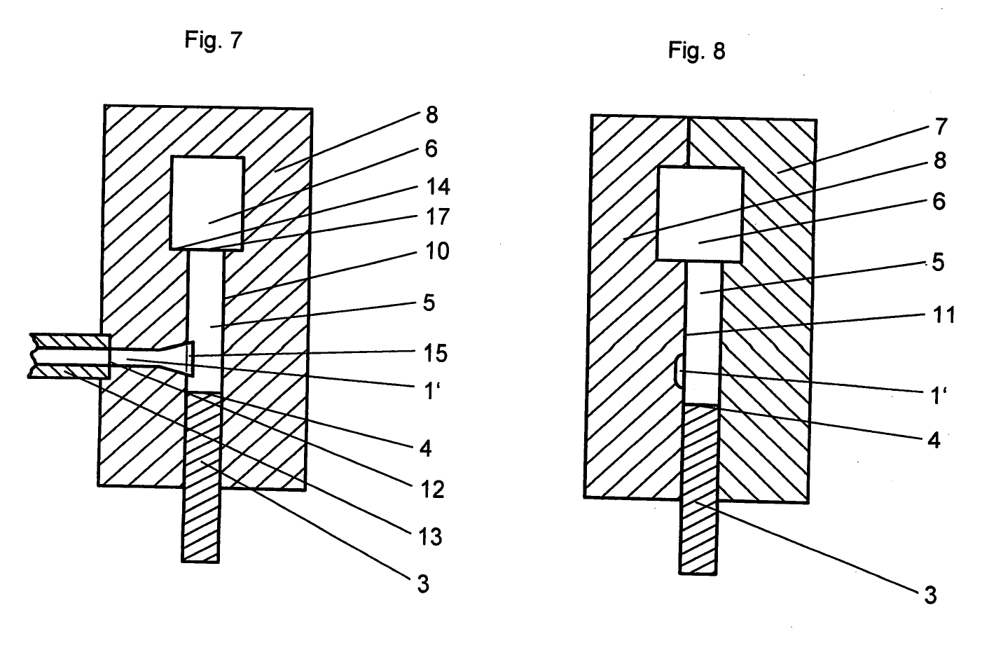

Reference will now be made to FIG. 7 which illustrates a top view of a cross-section of an open molding tool similar to that of FIG. 1, which shows the lower mold half 8 but with the supply pipe 1′ opening into the storage chamber 5 at a position in side of the storage chamber 5 through gate 15. The supply pipe 1′ is connected to the mixing head 13 through a connector 12 and receives reaction mixture from the mixing head. (The mixing head 13 is not part of the inventive apparatus.) The plunger 3 is shown in the retracted state, and the reaction mixture (not shown) will fill the storage chamber 5 at a sufficiently slow rate and adhere to the longitudinal side 1O of the storage chamber 5. Gravity is also used in this embodiment to prevent reaction mixture (not shown) from passing into the mold cavity 6 during filling of the storage chamber 5 as the opening 17 from the storage chamber 5 to the mold cavity 6 is located at the highest point of the storage chamber 5. Here, as in other embodiments, the plunger end face 4 will form part of the inside wall 14 of the mold cavity 6 of the molding tool when the plunger 3 is fully extended by closing or blocking the opening 17 through which the reaction mixture exits the storage chamber 5 and enters the mold cavity 6.

Reference will now be made to FIG. 8 which illustrates a side view of a cross-section of the closed molding tool of FIG. 7. Both upper mold half 7 and lower mold half 8 are shown, and the plunger 3 is in the retracted position. Filling of the storage chamber 5 with reaction mixture (not shown) is from the mixing head (not visible) through a connector (also not visible) through the supply pipe 1′. By extending the plunger 3, the reaction mixture (not shown) is transferred from the storage chamber 5 into the mold cavity 6, and the plunder end face 4 foams part of the mold cavity 6. Removal of the finished molding take place analogously to Example 1.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A molding tool for the production of plastics moldings by the reaction injection molding process, comprising one upper mold half and one lower mold half, which together form a mold cavity when in the closed position; a supply pipe for receiving and transporting a reaction mixture from an external source; a storage chamber for receiving the reaction mixture from the supply pipe, with the storage chamber being adjacent to the cavity formed by the molding tool halves; and a plunger which is movably arranged in the storage chamber, in which the plunger has an end face which forms part of the inside wall of the mold cavity formed by the molding tool halves when the plunger is in the extended state.

2. The molding tool of claim 1, wherein the gate of the supply pipe is located in the region of the storage chamber which is close to the plunger end face when the plunger is in the retracted state in the storage chamber.

3. The molding tool of claim 2, wherein the gate of the supply pipe is located directly at the plunger end face when the plunger is in the retracted state in the storage chamber.

4. The molding tool of claim 1, wherein the volume of the storage chamber is greater than or equal to the volume of the mold cavity which is formed by the upper and lower mold halves.

5. The molding tool of claim 1, wherein the supply pipe is located in the parting plane of the upper and lower mold halves.

6. The molding tool of claim 1, wherein the plunger is movably arranged in the direction of the parting plane of the upper and lower mold halves.

7. The molding tool of claim 1, wherein the plunger is movably arranged perpendicular to the parting plane of the upper and lower mold halves.

8. The molding tool of claim 1, in which the ratio of the width of the storage chamber to the length of the storage chamber is at least 1 to 3.

9. The molding tool of claim 8, in which the ratio of the width of the storage chamber to the length of the storage chamber is at least 1 to 4.

10. The molding tool of claim 1, wherein the storage chamber is located underneath the cavity formed by the upper and lower mold halves, and in which the opening of the storage chamber points up towards the mold cavity, such that the reaction mixture fills the storage chamber from bottom to top in accordance with gravity, and when the reaction mixture is moved from the storage chamber to the mold cavity, it enters the lowest portion of the mold cavity first.

11. A process for the production of plastics moldings by the reaction injection molding process, via the molding tool of claim 1, in which the reaction mixture comprises a polyurethane molding composition.

12. A process for the production of plastics moldings by the reaction injection molding process in which the reaction mixture comprises a polyurethane molding composition, via the molding tool of claim 1, comprising injecting the reaction mixture from a mixing head into the supply pipe via a connector, and into the storage chamber, within a period of less than 1 second; then, introducing the reaction mixture into the mold cavity with the aid of the plunger before the gel time of the reaction mixture; curing the reaction mixture in the mold cavity, and subsequently removing the resultant molding removed from the mold cavity.

13. The process of claim 12, in which the storage chamber is filled with an amount of reaction mixture which is not more than 15 cm³.
